(19) United States
(12) Patent Application Publication
(10) Pub. No.: US 2026/0192638 A1
(43) Pub. Date: Jul. 9, 2026

(54) VEHICLE WINDOW GLASS, CONTROL METHOD THEREOF, VEHICLE-MOUNTED PROJECTION SYSTEM AND PROJECTION FILM

(71) Applicant: SAINT-GOBAIN SEKURIT FRANCE, THOUROTTE (FR)

(72) Inventors: Lu WANG, SHANGHAI (CN); Yiheng ZHANG, SHANGHAI (CN); Ce SHI, SHANGHAI (CN)

(21) Appl. No.: 19/134,072

(22) PCT Filed: Nov. 28, 2023
(86) PCT No.: PCT/CN2023/134569

§ 371 Date: May 29, 2025

(30) Foreign Application Priority Data
Nov. 30, 2022 (CN) 202211522441.9

(51) Int. Cl. B60J 3/04; B60J 1/00; G02F 1/1333

(52) U.S. Cl. CPC B60J 3/04; B60J 1/001; G02F 1/133302

(57) ABSTRACT

A vehicle window glass adapted to be cooperated with a projection device to provide a projection function, wherein the vehicle window glass includes a first glass body, a second glass body, a haze adjusting layer sandwiched between the first glass body and the second glass body, and an imaging layer, and wherein the haze adjusting layer is configured to be capable of adjusting its haze to provide a projection effect and/or a privacy effect toward the outside and/or the inside of the vehicle on the imaging layer.

### FIELD

The present disclosure generally relates to the technical field of glass manufacturing, in particular to a vehicle window glass having projection function and a control method thereof, as well as a vehicle-mounted projection system realized by combining a projection device with the vehicle window glass having projection function and a projection film adapted to be attached to the vehicle window glass.

### BACKGROUND

With the rapid development of automobile industry, vehicle-mounted multimedia technology has been widely valued by vehicle manufacturers and favored by consumers. At present, the common vehicle-mounted projection systems in the market are mostly applied to the rear windshield of taxis, and the projection device is arranged on the components inside the vehicle to project advertising content to the outside of the vehicle, such as projecting pictures or video advertisements. The existing projection film has low light transmittance, excessive haze level, low resolution ratio, low clarity and small viewing angle. If it is applied to occasions such as vehicle door glass, it cannot meet the requirements of light transmittance and haze required by the vehicle door glass. In the projection mode to the outside, since the projected image is exposed to the environment, there is no low brightness environment in the vehicle for comparison, and the brightness demand for the projected image will be higher. For the projection mode to the inside of the vehicle (inward projection), since it is transparent projection, part of the light will inevitably scatter outward, so that people outside the vehicle can also see the projected image. Although the seen image is reversed from the actual image, it will still affect the privacy of users in the vehicle using the vehicle-mounted projection system, resulting in the users not being able to project some information that needs to be kept secret at will. The existing design realizes the privacy protection of the inward projection image by integrating a privacy film in the vehicle window glass, so that the user can watch any projected image in the vehicle with peace of mind. In addition, since the privacy film is dark film, it can also enhance the brightness of the image displayed by the inward projection. However, the vehicle manufacturers and most vehicle users or passengers continue to put forward higher requirements, hoping to adjust or improve the occasion of projecting images, image quality, image content privacy and vehicle internal privacy according to different requirements.

### SUMMARY

The purpose of the present disclosure is to improve the existing vehicle-mounted projection mode, hoping to provide information images in a diversified way through the vehicle window glass, and propose a vehicle window glass, a control method thereof and a vehicle-mounted projection system, which can switchably display any supported information to the inside and/or the outside of the vehicle according to different application occasions and user requirements, and provide privacy protection, through an imaging layer or a projection display layer and a haze adjusting layer with adjustable haze integrated in the vehicle window glass.

To this end, according to one aspect of the present disclosure, a vehicle window glass is provided. The vehicle window glass is adapted to be cooperated with a projection device to provide a projection function, wherein the vehicle window glass comprises a first glass body, a second glass body, a haze adjusting layer sandwiched between the first glass body and the second glass body, and an imaging layer, and wherein the haze adjusting layer is configured to be capable of adjusting its haze to provide a projection effect and/or a privacy effect toward the outside and/or the inside of the vehicle on the imaging layer.

By providing the haze adjusting layer, the vehicle window glass of the present disclosure can adjust its haze to project a clear image to the outside and/or the inside of the vehicle in combination with the imaging layer, and can switch the glass to be transparent or opaque when necessary, thus meeting the privacy requirements.

According to the above technical concept, the embodiment of the present disclosure may further include any one or more of the following alternative forms.

In some alternative forms, the vehicle window glass further comprises a first intermediate layer and a second intermediate layer which sandwich the haze adjusting layer between the first glass body and the second glass body, wherein the first intermediate layer is adjacent to the first glass body, the second intermediate layer is adjacent to the second glass body, and the second glass body is adapted to face the projection device.

In some alternative forms, the imaging layer is sandwiched between the second intermediate layer and the second glass body; or the imaging layer is directly attached to the haze adjusting layer and sandwiched between the haze adjusting layer and the second intermediate layer.

In some alternative forms, the imaging layer is sandwiched between the first intermediate layer and the first glass body; or the imaging layer is directly attached to the haze adjusting layer and sandwiched between the haze adjusting layer and the first intermediate layer.

In some alternative forms, the imaging layer is directly attached to a surface of the second glass body which is adapted to face the projection device.

In some alternative forms, the imaging layer is a projection film with or without back glue, so as to be directly attached to a surface of the second glass body which is adapted to face the projection device through the back glue or adhesive.

In some alternative forms, the imaging layer is directly attached to any one of the haze adjusting layer, the first glass body and the second glass body by back glue, adhesive or coating.

In some alternative forms, the imaging layer is configured as an orthographic projection imaging layer or a back projection imaging layer of any one of film layer, coating layer and micro-structure layer.

In some alternative forms, the imaging layer is a single layer film or is formed by laminating multiple layers of films.

In some alternative forms, the haze adjusting layer is further configured to be capable of adjusting its light transmittance and/or color.

In some alternative forms, the haze adjusting layer is configured as any one of polymer dispersed liquid crystal, polymer network liquid crystal, guest-host liquid crystal and negative liquid crystal.

In some alternative forms, the vehicle window glass comprises front windshield, rear windshield, skylight glass, vehicle door glass or corner window glass.

According to another aspect of the present disclosure, a vehicle-mounted projection system is provided. The vehicle-mounted projection system comprises a projection device and the above-mentioned vehicle window glass.

In some alternative forms, the first glass body faces the outside of the vehicle, the second glass body faces the inside of the vehicle, and the projection device is arranged inside the vehicle to project image to the outside and/or the inside of the vehicle through the vehicle window glass.

According to another aspect of the present disclosure, a method for controlling the above-mentioned vehicle window glass is provided, wherein the imaging layer is an orthographic projection imaging layer or a back projection imaging layer, and the method comprises: adjusting the haze of the haze adjusting layer to provide a projection effect and/or a privacy effect toward the outside and/or the inside of the vehicle.

In some alternative forms, the haze level of the haze adjusting layer is adjusted to be greater than or equal to 60% when the imaging layer is the back projection imaging layer, so as to provide a projection effect and a privacy effect toward the outside of the vehicle.

In some alternative forms, the haze level of the haze adjusting layer is adjusted to be less than or equal to 40% when the imaging layer is the back projection imaging layer, so as to provide a projection effect toward the outside of the vehicle.

In some alternative forms, the haze level of the haze adjusting layer is adjusted to be less than or equal to 40% when the imaging layer is the orthographic projection imaging layer, so as to provide a projection effect toward the inside of the vehicle.

In some alternative forms, the haze level of the haze adjusting layer is adjusted to be greater than or equal to 60% when the imaging layer is the orthographic projection imaging layer, so as to provide a projection effect and a privacy effect toward the inside and the outside of the vehicle.

According to another aspect of the present disclosure, a projection film adapted to be attached to a vehicle window glass is provided. The vehicle window glass comprises a first glass body, a second glass body, and a haze adjusting layer sandwiched between the first glass body and the second glass body, wherein the projection film is directly attached to a surface of the first glass body or the second glass body which is adapted to face a projection device through back glue or adhesive, and the haze adjusting layer is configured to be capable of adjusting its haze to provide a projection effect and/or a privacy effect toward the outside and/or the inside of the vehicle on the projection film.

The vehicle-mounted projection system disclosed by the present disclosure integrates a vehicle window glass having an imaging layer and a haze adjusting layer with a projection device, and can provide various supporting information to the inside and/or the outside of the vehicle without affecting the performance and aesthetics of the vehicle window glass itself. Through different optimized designs of the imaging layer and/or the haze adjusting layer, diversified display modes can be provided to meet different requirements of users and improve the user experience.

### BRIEF DESCRIPTION OF THE DRAWINGS

Other features and advantages of the present disclosure will be better understood by the following alternative embodiments described in detail in conjunction with the accompanying drawings, in which the last two identical reference numerals identify the same or similar parts, in the drawings:

FIG. 1 is a schematic view of a vehicle-mounted projection system according to an embodiment of the present disclosure, illustrating a schematic cross-sectional view of a vehicle window glass of a first embodiment;

FIG. 2 is similar to FIG. 1, illustrating a schematic cross-sectional view of a vehicle window glass of a second embodiment;

FIG. 3 is similar to FIG. 1, illustrating a schematic cross-sectional view of a vehicle window glass of a third embodiment;

FIG. 4 is similar to FIG. 1, illustrating a schematic cross-sectional view of a vehicle window glass of a fourth embodiment;

FIG. 5 is similar to FIG. 1, illustrating a schematic cross-sectional view of a vehicle window glass of a fifth embodiment.

### DETAILED DESCRIPTION OF EMBODIMENTS

The implementation and use of the embodiments are discussed in detail below. However, it should be understood that the specific embodiments discussed merely exemplify the specific ways of implementing and using the present disclosure, and do not limit the scope of the disclosure. When describing the structural positions of various components, such as the directions of upper, lower, top, bottom, etc., the description is not absolute, but relative. When the various components are arranged as shown in the figures, these directional expressions are appropriate, but when the positions of the various components in the figures would be changed, these directional expressions would also be changed accordingly.

In this context, the expression “comprising” or similar expressions “including”, “containing” and “having” which are synonymous are open, and do not exclude additional unlisted elements, steps or ingredients. The expression “consisting of . . . ” excludes any element, step or ingredient that is not specified. The expression “consisting essentially of . . . ” means that the scope is limited to the specified elements, steps or ingredients, plus the optional elements, steps or ingredients that do not materially affect the basic and new features of the claimed subject matter. It should be understood that the expression “comprising” covers the expressions “consisting essentially of” and “consisting of”.

In this context, the terms “first”, “second” and so on are not used to limit the sequence and the number of components unless otherwise stated.

In this context, unless otherwise specified, the terms such as “installation”, “connection” and “attach” should be understood broadly. For example, it can be fixed connection, detachable connection or integrated; it can be directly connected or indirectly connected through an intermediate medium, and it can be the internal communication of two components or the interaction between two components. For those skilled in the art, the specific meanings of the above terms in this context can be understood according to specific situations.

In this context, “outside” and “inside” are relative to the direction of vehicle body, “outside” refers to the direction away from the vehicle body, and “inside” refers to the direction facing the vehicle body.

In this context, “orthographic projection” means that the installation position of the projection device is located on the same side of the vehicle window glass as the observer, and the light emitted by the projection device projects onto the vehicle window glass to form an image, and then the light is reflected to the observer's eyes, also known as reflective projection, which is generally adapted to project images to the inside of the vehicle. “Back projection” means that the installation position of the projection device and the observer are located on both sides of the vehicle window glass, and the light emitted by the projection device is projected from one side of the vehicle window glass and enters the eyes of the observer on the other side through the vehicle window glass, also known as transmissive projection, which is generally adapted to project images to the outside of the vehicle.

As mentioned above, for the manufacturers and most vehicle users or passengers, it is hoped that transparent and opaque inward and/or outward projection can be realized at the same time and privacy requirements in some occasions can be met.

Therefore, according to the concept of the present disclosure, a vehicle window glass is provided. The vehicle window glass is adapted to cooperated with a projection device to provide a projection function. The vehicle window glass includes a first glass body, a second glass body, a haze adjusting layer sandwiched between the first glass body and the second glass body, and an imaging layer, wherein the haze adjusting layer is configured to be capable of adjusting its haze to provide a projection effect and/or a privacy effect toward the outside and/or the inside of the vehicle on the imaging layer. Here, “between” covers various arrangements in which the sandwiched haze adjusting layer is directly adjacent to or not directly adjacent to the first glass body or the second glass body. For example, in some embodiments, the haze adjusting layer can be attached to the first glass body or the second glass body through an intermediate layer and/or a functional layer, wherein the functional layer includes but is not limited to imaging layer, light emitting layer, heating layer, and the like, so as to be suitable for obtaining different functional effects.

In this context, the projected image is not limited, for example, it can be static words, numbers, symbols, graphics or pictures, and it can also be dynamic video or dynamic pictures.

Hereinafter, it is mainly described that the vehicle window glass is applied to the vehicle door glass of compact vehicle, but it is not excluded that the present disclosure can be applied to other transports such as buses, rail vehicles, airplanes or ships. Also, it should be understood that the vehicle window glass according to the present disclosure includes, but is not limited to, front windshield, rear windshield, skylight glass, vehicle door glass or corner window glass. In the various described embodiments, unless otherwise specified, the thickness of the glass is the thickness commonly used in the art, and the thickness of each laminated structure on the glass is suitable for the conventional range and is not limited as shown in the figures. In addition, although it is shown as plane glass in the figures, the vehicle window glass of the present disclosure may also be curved glass. In various embodiments, it is described as an independent glass body or glass plate, however, in some cases not described, the surface of the glass can also use special coating to improve other properties such as thermal insulation and/or comfort.

According to the present disclosure, the imaging layer is configured as an orthographic projection imaging layer or a back projection imaging layer of any one of film layer, coating layer and micro-structure layer. For example, in some embodiments, the imaging layer can be a polymer-based film layer or an inorganic-based film layer with nanoparticles and specific dopants, such as Ag, TiO₂, ZnO and other nanoparticles. In some embodiments, the imaging layer may be a micro-structure layer or a micro-texture layer with nano-scale or micro-scale structure, and may have a single-layer structure or a multi-layer structure design. In some embodiments, the imaging layer can be a directly coated coating layer or a film layer with or without back glue. In some embodiments, the imaging layer can be a single layer film or formed by laminating multiple layers of films.

According to the present disclosure, the haze adjusting layer is configured as any one of polymer dispersed liquid crystal (PDLC), polymer network liquid crystal (PNLC), guest-host liquid crystal (GHLC) and negative liquid crystal. The haze adjusting layer can control the haze level between 0.1% and 99.9%.

In this way, the vehicle window glass disclosed by the present disclosure integrates the haze adjusting layer and the imaging layer into the laminated glass at the same time, and through different combination designs of the haze adjusting layer and the imaging layer, the projection function of the vehicle window glass in transparent or opaque state can be realized by switching as required, and the inward projection and/or the outward projection display effect and privacy protection function on the same glass through the same projection device can be realized.

Specifically, aiming at whether the imaging layer is the orthographic projection imaging layer or the back projection imaging layer, the method for controlling the vehicle window glass of the present disclosure can include: adjusting the haze of the haze adjusting layer to provide a projection effect and/or a privacy effect toward the outside and/or the inside of the vehicle. In some embodiments, when the imaging layer is the back projection imaging layer, the haze level of the haze adjusting layer is adjusted to be greater than or equal to 60% to provide a projection effect and a privacy effect toward the outside of the vehicle. In some embodiments, when the imaging layer is the back projection imaging layer, the haze level of the haze adjusting layer is adjusted to be less than or equal to 40% to provide a projection effect toward the outside of the vehicle. In some embodiments, when the imaging layer is the orthographic projection imaging layer, the haze level of the haze adjusting layer is adjusted to be less than or equal to 40% to provide a projection effect toward the inside of the vehicle. In some embodiments, when the imaging layer is the orthographic projection imaging layer, the haze level of the haze adjusting layer is adjusted to be greater than or equal to 60% to provide a projection effect and a privacy effect toward the inside and the outside of the vehicle.

It should be understood that “privacy” in this context is usually for people inside the vehicle. When projecting outwardly, the switching of the haze adjusting layer from transparent to opaque can make people outside the vehicle observe the projected image but cannot see the situation inside the vehicle, thus realizing the privacy protection function; similarly, when projecting inwardly, people outside the vehicle cannot see the inside of the vehicle, while people inside the vehicle can observe the projected image.

The beneficial effects that can be achieved by various alternative combinations will be more clearly understood from the following description of several exemplary alternative embodiments.

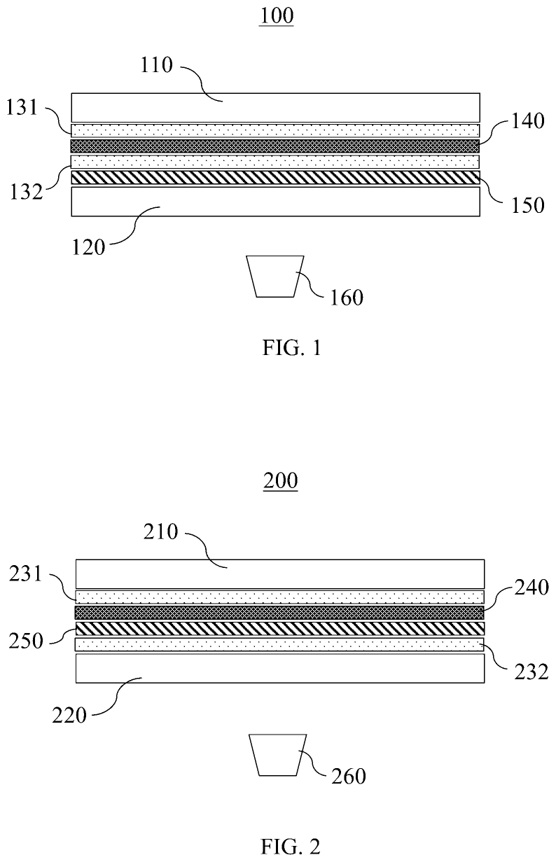

Specifically, according to a first embodiment shown in FIG. 1, a vehicle window glass 100 includes a first glass body 110 and a second glass body 120. A haze adjusting layer 140 is sandwiched between the first glass body 110 and the second glass body 120 through a first intermediate layer 131 and a second intermediate layer 132, and an imaging layer 150 is sandwiched between the second intermediate layer 132 and the second glass body 120, wherein the second glass body 120 is adapted to face a projection device 160, that is, a surface of the second glass body is used as an incident surface of the light emitted by the projection device.

In this embodiment, the first glass body 110 faces the outside of the vehicle, which may be called outer glass, and the second glass body 120 faces the inside of the vehicle, which may be called inner glass. The projection device 160 is arranged on the vehicle interior component, and the inner surface of the second glass body 120 facing the inside of the vehicle also faces the projection device at the same time, so that the projection device in the vehicle projects an image to the inside or the outside of the vehicle by using the vehicle window glass. The first intermediate layer 131 and the second intermediate layer 132 are adhesive layers suitable for the laminated glass, such as polyvinyl butyral (PVB) or ethylene-vinyl acetate copolymer (EVA). The imaging layer 150 can be in the form of film layer, such as a transparent back projection film without back glue, and the base material can be polyethylene terephthalate (PET), polyvinyl chloride (PVC), thermoplastic elastomer (TPE), polyurethane (PU) and other materials suitable for soft films. The haze adjusting layer 140 may be chosen as PDLC.

Under this arrangement, in some embodiments, since the haze adjusting layer 140 in the form of PDLC is a good display material for outward projection or back projection per se, when the power supply to the haze adjusting layer 140 is stopped to make it hazed (opaque), for example, the haze level is adjusted to be greater than or equal to 60%, for example, greater than or equal to 65%, greater than or equal to 70%, greater than or equal to 75%, greater than or equal to 80%, greater than or equal to 85%, greater than or equal to 90%, greater than or equal to 95%, . . . until 99.9%. Preferably 80%-99.9%, more preferably 95%-99.9%. Both the hazed PDLC film and the transparent back projection film are good external scattering media. The image projected by the projection device in the vehicle is intercepted by the imaging layer 150 and the haze adjusting layer 140 at the same time, and the image is formed with enhanced superposition, which makes the image brighter and clearer, and enhances the brightness of the displayed image of the outward projection, thus enhancing the outward projection effect. At the same time, the hazed PDLC film also plays the role of privacy protection, so that the inside of the vehicle cannot be seen from outside, and the good privacy of the interior of the vehicle is maintained. In this state, the vehicle window glass is suitable for realizing the functions of welcoming and vehicle inspection, etc., in which the driver or the passenger can perform information interaction with the driver or the passenger before getting on the vehicle. When the haze adjusting layer 140 is energized, the PDLC film is switched to a transparent state, for example, the haze level is adjusted to be less than or equal to 40%, for example, less than or equal to 35%, less than or equal to 30%, less than or equal to 25%, less than or equal to 20%, less than or equal to 15%, less than or equal to 10%, less than or equal to 5%, . . . until 0.1%. Preferably 0.1%-10%, more preferably 0.1%-5%. In this state, the vehicle window glass becomes transparent, and the function of transparent outward display can be obtained, which is suitable for scenes where information needs to be displayed and the driver or the passenger needs to observe external conditions when interacting with other vehicles or pedestrians outside the vehicle.

When the imaging layer 150 is selected as the orthographic projection film, the vehicle window glass 100 can also obtain a satisfactory projection effect to the outside and/or the inside of the vehicle and a required privacy effect. For example, when the haze level is adjusted to 0.1%-10% by the haze adjusting layer 140, the projected image can be clearly seen inside the vehicle, and the scene outside the window can be clearly seen at the same time. When the haze level is adjusted to 80%-99.9%, clear images can be seen both inside and outside the vehicle due to the good outward projection performance of the haze adjusting layer itself, and at the same time, good privacy can be maintained inside the vehicle since the glass is opaque.

Different from the existing design, by reasonably selecting the haze adjusting layer and optimizing the structural design, the switching of the haze adjusting layer from transparent to opaque state (hazed state) can significantly improve the clarity of the image projected by the imaging layer, and realize that the projection device can project the image toward the inside and/or the outside of the vehicle via the orthographic projection mode or the back projection mode when the projection device is in the vehicle, and has the function of protecting the privacy of the vehicle interior. Besides PDLC, other haze adjusting layers such as PNLC, GHLC and reverse PDLC can also achieve similar effects. For the adjusting range and specific values of the haze level, those skilled in the art can obtain various feasible solutions to meet different requirements based on the concept of the present disclosure, which are not listed exhaustively here.

In some embodiments, the haze adjusting layer can also adjust light transmittance and/or color, for example, the haze adjusting layer in the form of PDLC or GHLC. When the light transmittance is adjusted to be dark (still transparent), the enhanced projection effect can be obtained when projecting to the inside or the outside of the vehicle.

FIG. 2 exemplarily illustrates a second embodiment. In this embodiment, similar to FIG. 1, a vehicle window glass 200 includes a first glass body 210 and a second glass body 220, and a haze adjusting layer 240 is sandwiched between the first glass body 210 and the second glass body 220 through a first intermediate layer 231 and a second intermediate layer 232, wherein the second glass body 220 is adapted to face a projection device 260. The difference is that an imaging layer 250 is directly attached to the haze adjusting layer 240 and sandwiched between the haze adjusting layer 240 and the second intermediate layer 232, that is, there is no need to have an intermediate layer between the imaging layer 250 and the haze adjusting layer 240.

In some embodiments, the imaging layer 250 can adopt a projection film without back glue as in the above-mentioned embodiments, or can also adopt a projection film with back glue, so as to be directly attached to the haze adjusting layer 240 by bonding. In some embodiments, the imaging layer 250 may take the form of a coating layer and be directly attached to the haze adjusting layer 240 by coating. As an example, the imaging layer 250 may be coated on the haze adjusting layer 240 to form a whole. In this way, the base solution of the imaging layer 250 is advantageously selected as a material that can adhere to the base material (e.g., PET) of the haze adjusting layer (e.g., PDLC).

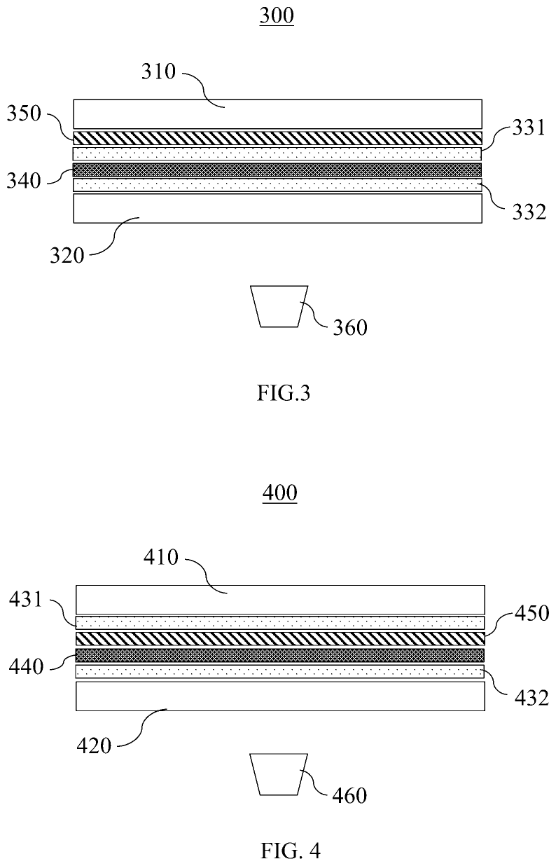

A third embodiment shown in FIG. 3 is similar to that in FIG. 1. In this embodiment, a vehicle window glass 300 includes a first glass body 310 and a second glass body 320, and a haze adjusting layer 340 is sandwiched between the first glass body 310 and the second glass body 320 through a first intermediate layer 331 and a second intermediate layer 332, wherein the second glass body 320 is adapted to face a projection device 360. The difference is that the imaging layer 350 is sandwiched between the first intermediate layer 331 and the first glass body 310.

A fourth embodiment shown in FIG. 4 is similar to that in FIG. 2. In this embodiment, a vehicle window glass 400 includes a first glass body 410 and a second glass body 420, and a haze adjusting layer 440 is sandwiched between the first glass body 410 and the second glass body 420 through a first intermediate layer 431 and a second intermediate layer 432, wherein the second glass body 420 is adapted to face a projection device 460. The difference is that the imaging layer 450 is directly attached to the haze adjusting layer 440 and sandwiched between the haze adjusting layer 440 and the first intermediate layer 431.

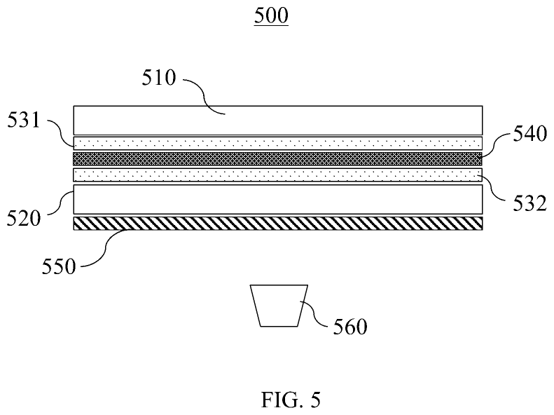

FIG. 5 illustrates a fifth embodiment. In this embodiment, a vehicle window glass 500 includes a first glass body 510 and a second glass body 520, and a haze adjusting layer 540 is sandwiched between the first glass body 510 and the second glass body 520 through a first intermediate layer 531 and a second intermediate layer 532, wherein the second glass body 520 is adapted to face a projection device 560. Different from the above embodiment, the imaging layer 550 is directly attached to the second glass body 520, that is, the imaging layer 550 is directly attached to the inner surface of the second glass body 520 facing the projection device 560, i.e., the air surface. In this way, the imaging layer 550 can be chosen as a projection film with back glue to be directly adhered to the inner surface, or the imaging layer can be adopted as a coating layer to be attached to the inner surface by coating. As an example, the imaging layer 550 in the form of a coating layer may be coated on the air surface of the second glass body 520 to be formed as a whole. When the imaging layer in the form of projection film is selected, besides the projection film with back glue, the projection film without back glue can also be selected and attached to the inner surface of the second glass body by adhesive. As an example, the adhesive can be optical adhesive (OCA).

Regardless of the arrangement and combination mode, the vehicle window glass disclosed by the present disclosure advantageously integrates the functions of inward projection and outward projection on the same glass, and can combine the projection device inside the vehicle to enable the observer to see a satisfactory projection effect by means of orthographic projection or back projection without affecting the structural performance and aesthetics of the vehicle window glass itself, and can provide privacy effect as required. It should be understood that other listed but not detailed alternative forms of the haze adjusting layers can adopt similar structural combinations and achieve the same or similar above-mentioned effects.

By applying the vehicle window glass to the vehicle-mounted projection system, the projection device can display the projected image to the outside and/or the inside of the vehicle through the vehicle window glass such as vehicle door glass, windshield glass and skylight, thus increasing the projection display area and meeting various intelligent interaction requirements. Advantageously, the projection device and the vehicle window glass can communicate via the human-machine interaction unit, so that the projection device can project an image to the vehicle window glass in response to the control signal sent by the human-machine interaction unit, and the human-machine interaction unit can communicate with the vehicle window glass and/or the projection device through an external interface and/or a wireless transceiver. Optionally, the external interface includes but is not limited to USB interface, HDMI interface, etc. The wireless transceiver includes, for example, Wi-Fi chip, Bluetooth chip, etc., so that it can communicate with the vehicle window glass and/or the projection device having wireless communication function.

Alternatively, the human-machine interaction unit may include at least one of human-machine interface (HMI), head-up display (HUD) and automatic driving system (ADAS). Alternatively, the human-machine interaction unit may include at least one of voice module (for example, microphone), image module (for example, camera), key module (for example, film key, mechanical key), touch module, gesture module (for example, infrared sensor), and remote control module. Therefore, the human-machine interaction unit, as the input end of the vehicle-mounted projection system, feeds back the information input by the operator in various ways to the system and outputs it to the projection device, and then outputs it to the imaging layer of the vehicle window glass by means of projection. Especially for the way of inward projection on the vehicle door glass, it can be used for the driver or the passenger to safely and conveniently implement various functional operations, such as but not limited to: air conditioning temperature adjusting, volume adjusting, radio channel switching, etc.

It should be understood here that the embodiments shown in the drawings only illustrate the optional architectures, shapes, sizes and arrangements of various optional components of a vehicle window glass having an imaging layer and a haze adjusting layer in a vehicle-mounted projection system according to the present disclosure; however, it is only illustrative rather than restrictive, and other shapes, sizes and arrangements can be adopted without departing from the spirit and scope of the present disclosure.

The technical content and technical features of the present disclosure have been disclosed above. However, it can be understood that those skilled in the art can make various changes and improvements to the above disclosed concept under the creative idea of the present disclosure, all of which fall within the protection scope of the present disclosure. The description of the above embodiments is illustrative rather than restrictive, and the protection scope of the present disclosure is determined by the claims.

1. A vehicle window glass adapted to be cooperated with a projection device to provide a projection function, wherein the vehicle window glass comprises a first glass body, a second glass body, a haze adjusting layer sandwiched between the first glass body and the second glass body, and an imaging layer, and wherein the haze adjusting layer is configured to be capable of adjusting its haze to provide a projection effect and/or a privacy effect toward the outside and/or the inside of the vehicle on the imaging layer.

2. The vehicle window glass according to claim 1, wherein the vehicle window glass further comprises a first intermediate layer and a second intermediate layer which sandwich the haze adjusting layer between the first glass body and the second glass body, and wherein the first intermediate layer is adjacent to the first glass body, the second intermediate layer is adjacent to the second glass body, and the second glass body is adapted to face the projection device.

3. The vehicle window glass according to claim 2, wherein the imaging layer is sandwiched between the second intermediate layer and the second glass body; or the imaging layer is directly attached to the haze adjusting layer and sandwiched between the haze adjusting layer and the second intermediate layer.

4. The vehicle window glass according to claim 2, wherein the imaging layer is sandwiched between the first intermediate layer and the first glass body; or the imaging layer is directly attached to the haze adjusting layer and sandwiched between the haze adjusting layer and the first intermediate layer.

5. The vehicle window glass according to claim 2, wherein the imaging layer is directly attached to a surface of the second glass body which is adapted to face the projection device.

6. The vehicle window glass according to claim 5, wherein the imaging layer is a projection film with or without back glue, so as to be directly attached to a surface of the second glass body which is adapted to face the projection device through the back glue or adhesive.

7. The vehicle window glass according to claim 2, wherein the imaging layer is directly attached to any one of the haze adjusting layer, the first glass body and the second glass body by back glue, adhesive or coating.

8. The vehicle window glass according to claim 1, wherein the imaging layer is configured as an orthographic projection imaging layer or a back projection imaging layer of any one of film layer, coating layer and micro-structure layer.

9. The vehicle window glass according to claim 8, wherein the imaging layer is a single layer film or is formed by laminating multiple layers of films.

10. The vehicle window glass according to claim 1, wherein the haze adjusting layer is further configured to be capable of adjusting its light transmittance and/or color.

11. The vehicle window glass according to claim 1, wherein the haze adjusting layer is configured as any one of polymer dispersed liquid crystal, polymer network liquid crystal, guest-host liquid crystal and negative liquid crystal.

12. The vehicle window glass according to claim 1, wherein the vehicle window glass comprises front windshield, rear windshield, skylight glass, vehicle door glass or corner window glass.

13. A vehicle-mounted projection system, wherein the vehicle-mounted projection system comprises a projection device and a vehicle window glass according to claim 1

14. The vehicle-mounted projection system according to claim 13, wherein the first glass body faces the outside of the vehicle, the second glass body faces the inside of the vehicle, and the projection device is arranged inside the vehicle to project image to the outside and/or the inside of the vehicle through the vehicle window glass.

15. A method for controlling a vehicle window glass according to claim 1, wherein the imaging layer is an orthographic projection imaging layer or a back projection imaging layer, and the method comprises:
adjusting the haze of the haze adjusting layer to provide a projection effect and/or a privacy effect toward the outside and/or the inside of the vehicle.

16. The method according to claim 15, wherein the haze level of the haze adjusting layer is adjusted to be greater than or equal to 60% when the imaging layer is the back projection imaging layer, so as to provide a projection effect and a privacy effect toward the outside of the vehicle.

17. The method according to claim 15, wherein the haze level of the haze adjusting layer is adjusted to be less than or equal to 40% when the imaging layer is the back projection imaging layer, so as to provide a projection effect toward the outside of the vehicle.

18. The method according to claim 15, wherein the haze level of the haze adjusting layer is adjusted to be less than or equal to 40% when the imaging layer is the orthographic projection imaging layer, so as to provide a projection effect toward the inside of the vehicle.

19. The method according to claim 15, wherein the haze level of the haze adjusting layer is adjusted to be greater than or equal to 60% when the imaging layer is the orthographic projection imaging layer, so as to provide a projection effect and a privacy effect toward the inside and the outside of the vehicle.

20. A projection film adapted to be attached to a vehicle window glass, wherein the vehicle window glass comprises a first glass body, a second glass body and a haze adjusting layer sandwiched between the first glass body and the second glass body, and wherein the projection film is directly attached to a surface of the first glass body or the second glass body which is adapted to face a projection device through back glue or adhesive, and the haze adjusting layer is configured to be capable of adjusting its haze to provide a projection effect and/or a privacy effect toward the outside and/or the inside of the vehicle on the projection film.
